(19) United States
(12) Patent Application Publication
(10) Pub. No.: US 2026/0073715 A1
(43) Pub. Date: Mar. 12, 2026

(54) GEOSPATIAL INTELLIGENCE PLATFORM

(71) Applicant: GRANULAR DATA, INC., BELMONT, MA (US)

(72) Inventors: SIDDHARTH GUPTA, BELMONT, MA (US); SAGAR VERMA, BELMONT, MA (US)

(21) Appl. No.: 18/707,801

(22) PCT Filed: Nov. 4, 2022
(86) PCT No.: PCT/US2022/048967

§ 371 Date: May 6, 2024

Related U.S. Application Data
(60) Provisional application No. 63/276,439, filed on Nov. 5, 2021.

(51) Int. Cl. G06V 20/70; G06N 20/00; G06V 10/25

(52) U.S. Cl. CPC G06V 20/70; G06N 20/00; G06V 10/25

(57) ABSTRACT

The present disclosure generally relates to systems and techniques for geospatial image processing. Certain aspects of the present disclosure provide a method for geospatial image processing. The method generally includes providing a user interface for annotating one or more geospatial images, receiving at least one annotation for the one or more geospatial images from a user device, generating a training dataset based on the at least one annotation, and training a first machine learning model for features identification in geospatial images via the training dataset.

### CROSS-REFERENCE TO RELATED APPLICATION

This application claims priority to provisional patent application U.S. Ser. No. 63/276,439, filed Nov. 5, 2021, the content of which is incorporated by reference herein in its entirety.

### FIELD

The present disclosure generally relates to systems and techniques for geospatial image processing.

### BACKGROUND

In order to address many of humanity's biggest challenges, it is important to develop a thorough understanding of our planet and how it is evolving. Satellite and aerial imagery combined with geospatial machine learning offer an unparalleled source of objective global-scale data. A significant increase in the number of earth observation satellites deployed to orbit has occurred, with similar growth in the availability of commercial aerial images obtained via fixed-wing planes and balloons. Moreover, small unmanned aerial vehicles (UAVs) in both the retail and commercial markets are generating a plethora of geospatial data. This recent increase in aerial data (e.g., multispectral, synthetic-aperture radar (SAR), light detection and ranging (LIDAR)), as well as non-image geospatial data (e.g., global positioning system (GPS)), has radically changed the potential for downstream applications. As such data becomes cheaper and more readily available, corporations, governments, and citizens seek to leverage it to better understand our planet and its inhabitants.

### BRIEF SUMMARY

Certain aspects of the present disclosure are directed towards a method for geospatial image processing. The method generally includes: providing a user interface for annotating one or more geospatial images; receiving at least one annotation for the one or more geospatial images from a user device; generating a training dataset based on the at least one annotation; and training a first machine learning model for features identification in geospatial images via the training dataset.

Certain aspects of the present disclosure are directed towards a non-transitory computer-readable medium having instructions stored thereon, which when executed by at least one processor, causes the at least one processor to: provide a user interface for annotating one or more geospatial images; receive at least one annotation for the one or more geospatial images from a user device; generate a training dataset based on the at least one annotation; and train a first machine learning model for features identification in geospatial images via the training dataset.

Certain aspects of the present disclosure are directed towards a system for geospatial image processing. The system generally includes: a user interface subsystem configured to provide a user interface for annotating one or more geospatial images and receive at least one annotation for the one or more geospatial images from a user device; a data processing component configured to generate a training dataset based on the at least one annotation; and a training component configured to train a first machine learning model for features identification in geospatial images via the training dataset.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example computing device, in accordance with some examples.

FIG. 2 illustrates an example architecture of a geospatial processing system, in accordance with certain aspects of the present disclosure.

FIG. 3 illustrates example operations for image sourcing, in accordance with certain aspects of the present disclosure.

FIG. 4 illustrates example operations for dataset development, in accordance with certain aspects of the present disclosure.

FIG. 5 illustrates example operations for dataset creation including annotation and labeling, in accordance with certain aspects of the present disclosure.

FIG. 6 illustrates example techniques for generating a model performance report, in accordance with certain aspects of the present disclosure.

FIG. 7 illustrates example operations for geospatial image processing, in accordance with certain aspects of the present disclosure.

FIG. 8 illustrates example techniques for feature identification, in accordance with certain aspects of the present disclosure.

FIG. 9 illustrates an architecture of a computing system.

### DETAILED DESCRIPTION

Certain aspects and aspects of this disclosure are provided below and some of these aspects may be applied independently and some of them may be applied in combination. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Certain aspects provide a cloud-based solution that enables geospatial machine learning development by geospatial artificial intelligence (AI) systems, exposing geospatial abstractions, managing machine learning (ML) application lifecycles, and simplifying hardware provisioning. Geospatial imagery may be used to interrogate areas of a map. These areas may be large in size. For example, geospatial imagery may be used to interrogate a border between two countries. Therefore, a manual process for reviewing geospatial imagery may not be feasible. Machine learning techniques may be used to interrogate a large area over time and on a recurring basis. Certain aspects develop a machine learning dataset for geospatial data to facilitate the training and deployment of machine learning systems. Certain aspects provide global scale analytics capabilities to empower decision-making using geospatial data. Certain aspects standardize data interactions from image ingestion through application deployment. The framework provided herein reduces data management complexity and human-in-the-loop operations.

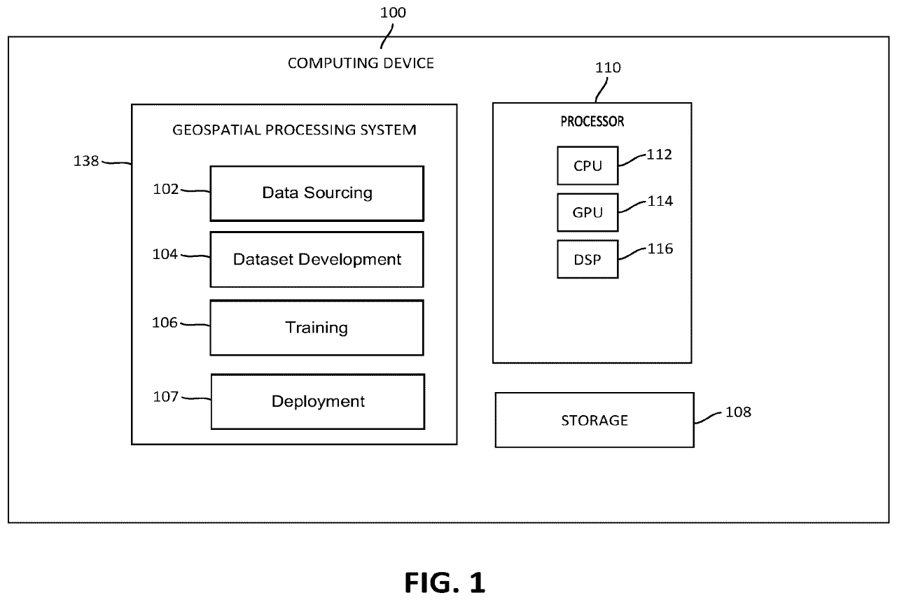

FIG. 1 is a diagram illustrating an example computing device 100, in accordance with some examples. In the example shown, the computing device 100 may include storage 108, processor 110, and memory controller 112. Storage 108 can include any storage device(s) for storing data. The storage 108 can store data from any of the components of the computing device 100. In some implementations, the processor 110 can include a central processing unit (CPU) 112, a graphics processing unit (GPU) 114, and/or a digital signal processor (DSP) 116. In some aspects, the computing device 100 includes a geospatial processing system 138. Geospatial processing system 138 may also include a user interface subsystem.

The geospatial processing system 138 may include a data sourcing component 102 which may be used to collect geospatial images (e.g., from satellites). The data sourcing component 102 provides a framework for building large complex datasets from aerial imagery through a web user interface (UI) and complementary application programming interface (API). The data sourcing component 102 provides image sourcing abstraction via a plugin-based approach to support different image sources. The geospatial processing system 138 may also include a dataset development component 104 which may facilitate image annotation for generating a training dataset. For example, the dataset development component 104 may host a user interface displaying geospatial imagery, allowing a user device to select areas of the image and label the area as being associated with a feature. In some cases, the dataset development component 104 may host a machine learning model to provide recommendations of labels, as described herein. The geospatial processing system 138 may also include a training component 106 that facilitates the training of a machine learning model using the generated training dataset. For example, the training component 106 may host a user interface to receive requests of experiments (e.g., variations of data or variables) to be run on the machine learning model for training. The geospatial processing system 138 may also include a deployment component 107 that deploys a trained machine learning model, allowing research and auditing of the machine learning model.

Geospatial machine learning has seen advancement, but its practical application has been constrained by difficulties with operationalizing performance and reliable solutions. Sourcing satellite and aerial imagery in real-world settings, handling a large amount of training data, and managing machine learning artifacts are a few of the challenges that have limited innovation. Certain aspects of the present disclosure are directed towards a geo-engine platform for reproducible and production-ready geospatial machine learning research. The geo-engine removes key technical hurdles to adopting computer vision and deep learning-based geospatial solutions at scale. The geo-engine described herein is an end-to-end geospatial machine learning platform, simplifying access to insights locked behind petabytes of imagery. Backed by a rigorous research methodology, this geospatial framework empowers researchers with abstractions for image sourcing, dataset development, model development, large scale training, and model deployment. The present disclosure provides an architecture for implementing the geo-engine and provides several real-world use cases of image sourcing, dataset development, and model building for deploying geospatial solutions.

The machine learning development lifecycle mirrors that of software development, with four key stages: planning, development, testing and deployment. Similarly, maintaining machine learning (ML) systems involve ongoing care to that of conventional software systems, from identifying faulty logic and applying appropriate fixes to improving features and performance. To carry out these processes, software development relies on development operations to streamline development while continuously delivering new releases and maintaining quality. The workflow for machine vision models follows a similar pattern. Where development of machine vision models differs from a typical software development project is in the operating environment. These development practices diverge when it comes to the deterministic nature of software development juxtaposed to the inherently probabilistic nature of computer vision development. Further, as recent global events have demonstrated, the planet is constantly changing, so developing the real-world data that powers their models will inevitably change as well. For instance, a model used to determine construction activity will remain relevant only as long as construction practices, materials and design remain consistent. The apparent similarities between these two development practices have led to an increasing drive to build development operations (DevOps) systems for machine learning. Machine learning operations (MLOps) platforms systematize the process of building and training experimental machine learning models and translating them into production. MLOps platforms for computer vision can serve multiple purposes, with some common functions including data sourcing and broadcasting, image data management, dataset development, model metadata and artifact management, model validation and operationalization.

Along with complexities specific to geospatial data, such as sensor and image qualities and map projection, problems around data representation, data access limitations, and performance issues with working with large geospatial images make many platforms ill-suited for geospatial research.

Certain aspects of the present disclosure provide an MLOps tool focused on geospatial machine learning. The geo-engine described herein creates and manages large, annotated datasets, converts them into analysis-ready datasets, launches efficient training pipelines, stores and versions training artifacts, and deploys geospatial model application program interfaces (APIs) for consumption in real-world scenarios with unseen data. There are additional features that are oriented toward geospatial and remote sensing research problems as well as in-production solutions, such as live sourcing satellite imagery, rendering analytical data to maps and managing vector data for time-series datasets.

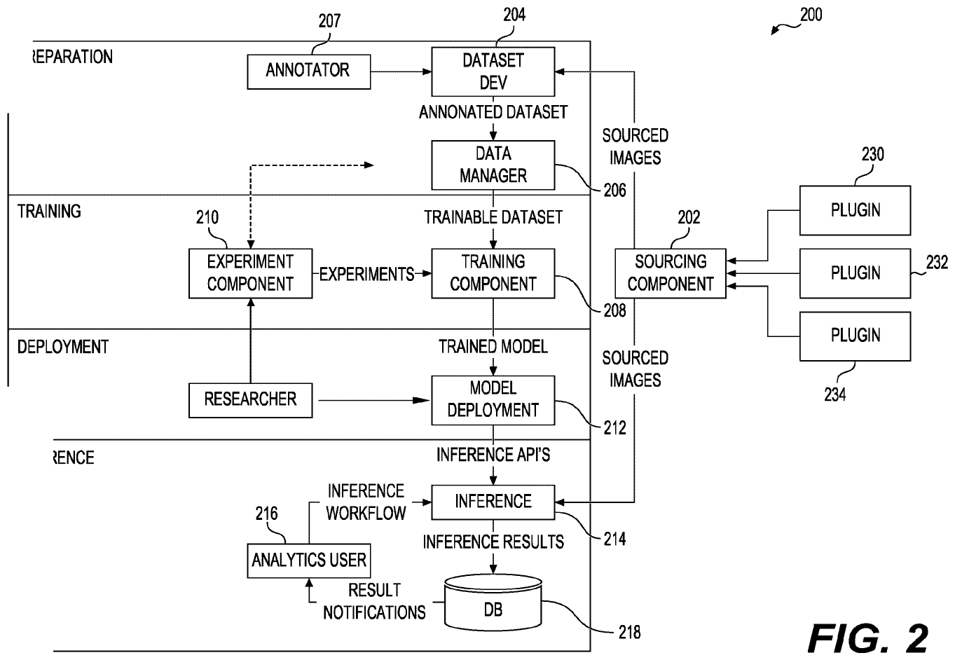

FIG. 2 illustrates an example architecture of a geospatial processing system 200 providing four core functions, including preparation, training, deployment, and inference, in accordance with certain aspects of the present disclosure. Preparation involves reading input data for geo machine learning (ML) modeling, storage, dissemination, and AI-in-the-loop data labeling. Training involves facilitating hardware and software specifications around model training, including environment management, and cloud and local hardware (CPU/GPU/Memory) provisioning. Deployment involves packaging models to run as standalone APIs, including rigorous metadata checks, model benchmarking and validation. Inference involves running a deployed model for a target region of interest, including management for regional “subscriptions” and feed data, and integration with geographic information systems (GIS)/analytical tools. The geospatial processing system 200 described herein enables a user to create large datasets from scratch, manage model training and deploy real-world solutions.

As shown, different software plugins 230, 232, 234 may be provided to facilitate input of data from various sources (e.g., satellites or drones). A plugin, also called an add-on or extension, is a computer software that adds new functions to a host program without altering the host program itself. For example, plugins may be used to tailor data input functionality for each of the different data sources (e.g., vendors). In other words, the plugins allow for the creation of a single interface to source data from different vendors. The data collected via the plugins 230, 232, 234 may be provided to a sourcing component 202 configured to output the data in a standardized format such that the collection of data from the different sources can be used for AI development (e.g., machine learning model training). The image sourcing component 202 may be implemented as a microservice that provides capability through endpoints to query and download satellite and aerial images. The image sourcing component 202 interacts with several geospatial image providers to automate the retrieval of geospatial images in a structured and efficient manner. The sourcing component 202 also provides the functionality of adding private images via custom storage buckets.

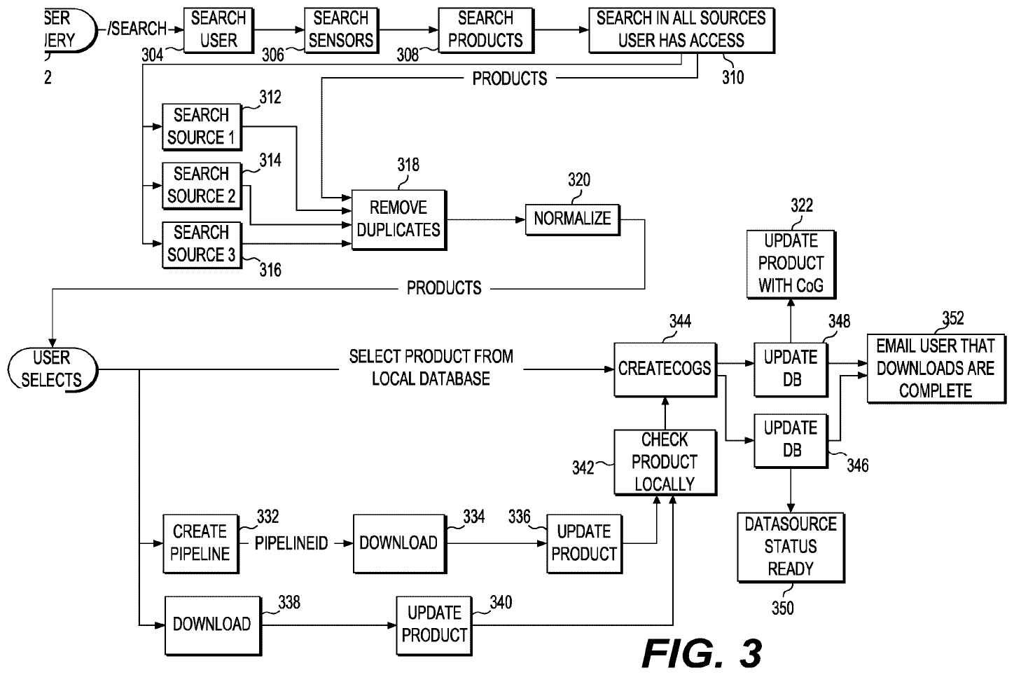

FIG. 3 illustrates example operations for image sourcing, which may be performed by the image sourcing component 202, in accordance with certain aspects of the present disclosure. At block 302, the image sourcing component 202 may receive a user query and at block 304, perform an associated user search. For example, the user may request an image at a particular location, for a specific date, coverage (e.g., cloud cover), resolution, and buffer (e.g., number of days). At block 306, the image sourcing component 202 may search sensors (e.g., image source such as any camera that may be on a satellite or drone) and provide a list of sensors (e.g., sensors that match the resolution requested by the user and which the user has access to). At block 308, the image sourcing component 202 may perform a search of products (e.g., a timestamped image) associated with various input criteria such as location, date, buffer, coverage, and sensors, providing a list of products that meet such input criteria. Products may be images of a particular city, each of the images being associated with a time stamp indicating a time of capture of the image. At block 310, the image sourcing component 202 may perform a search of various sources the user has access to for the sensors and products, based on inputs including an indication of the sensors, products, location, date, buffer, and coverage. At blocks 312, 314, 316, the image sourcing component 202 performs a search of various image sources such as satellites for images, based on location, date, buffer, and coverage. The source results from blocks 312, 314, 316 may be reviewed for duplicate removal at block 318. For example, some results returned from sources may already be in the products, and such duplicates may be removed to avoid redownloading. At block 320, the results (after duplicate removal) may be normalized. For example, the results may be set to have the same structure with each item (e.g., geospatial image) having a status (e.g., status being whether the result is locally available or should be retrieved from one or more other entities). For example, at block 324, the user selects the retrieved results (e.g., images) from one or more of the various sources. For items that are to be retrieved from source 1, a pipeline may be created, at block 332, for retrieving the items. At block 334, the associated file may be downloaded using the pipeline created at block 332, and at block 336, the product is updated with the retrieved items. In some cases, for items to be downloaded from source 2, at block 338, the associated file may be downloaded (e.g., using the created pipeline based on a pipeline ID), and at block 340, the product may be updated accordingly. Once downloaded, the item status may be updated to show that the item is now available locally. At block 342, the local product may be registered (e.g., stored) in the local database), and at block 344, cloud-optimized GeoTiffs (CoGs) are created. At blocks 348, 346, databases (e.g., databases associated with image sourcing component 202 and dataset development component 204) may be updated to include the created CoGs. For example, at block 322, the product at the image sourcing component 202 may be updated, and at block 350, the data source status at the dataset development component 204 may be set to ready. At block 352, the user may be emailed to notify the user that the downloads are completed.

Referring back to FIG. 2, images sourced by the image sourcing component 202 may be provided to a dataset development component 204 which enables the search for images for annotation tasks. As shown, the dataset development component 204 receives the sourced images from the image sourcing component 202, and based on input from an annotator 207, generates an annotated dataset. The dataset development component 204 enables users to readily ingest image sources, public or private, supports a broad array of remote sensing and vision problems, delivers high-quality model training data, and allows for sharing of datasets adhering to open and reproducible standards. Of the various remote sensing and vision problems, change detection is a notably challenging requirement. Change detection involves the ability to track changes in a given area of interest across multiple dates, which requires the ability to swap the image context in which the annotation is situated. To create high-quality annotations, the dataset development component 204 may include several key features. Firstly, dataset development component 204 may allow for sufficiently large datasets. Secondly, dataset development component 204 may support a multitude of image types, different bands, and as described, multi-date image sets. Lastly, a systematic validation process is important in both training annotators and correcting mistakes during the annotations. In addition to the annotation process, the application may allow for easy sharing and importing of datasets. This feature would allow users to quickly begin testing hypotheses and further improve existing imported or annotated datasets. The system described herein facilitates versioning, forking (e.g., splitting), extending, and sharing of geospatial data assets to allow for collaborative geospatial experimentation and machine learning. For example, different versions of geospatial data assets may be tracked on the platform and shared among users.

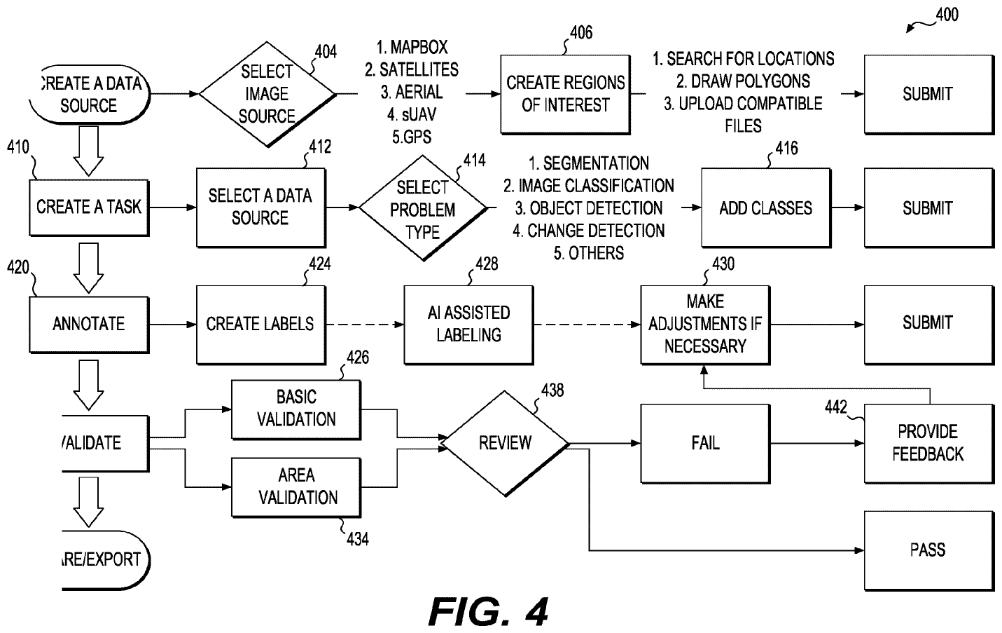

FIG. 4 illustrates example operations 400 which may be performed by the dataset development component 204, in accordance with certain aspects of the present disclosure. The dataset development component 204 may facilitate remote data access that are created, as described herein. The dataset development component 204 may include the user interface subsystem and may provide a user interface that facilitates data development. For example, at block 402, the dataset development component 204 may create a data source by first selecting an image source at block 404. At block 406, creating the data source may involve receiving (e.g., from a user) a selection of an image source (e.g., via the user interface), such as a 3^{rd}-party WMS basemap, open geospatial consortium (OGC) baselayer, satellites, aerial imagery source, or small unmanned aerial vehicle (sUAV). The user may also create regions of interest by searching for a specific location, drawing polygons (e.g., on a map), and uploading compatible files.

Once a data source is created via the user interface, a task may be created at block 410. For example, a user may select a data source at block 412, and select a problem type at block 414, such as segmentation, image classification, object detection, change detection, or any other problem. Change detection may involve detecting that geospatial imagery has changed from one date to another, and may provide a polygon to indicate where a change has occurred. Classification may involve classifying an image (e.g., for a single date) at block 416. In some cases, the dataset development component 204 may facilitate the segmentation of images for efficient ML processing. Segmentation may involve segmenting an image (e.g., for a single date) into various sub-regions and providing those segments to the user. The dataset development component 204 may also facilitate object detection (e.g., detecting houses or trees) in images. For example, an object may be detected, and a rectangular box may be presented around the object in the image to facilitate annotation.

At block 420, the dataset development component 204 may facilitate the annotation of images for ML processing. For example, at block 424, a user may create a label for an image (or a subset of an image). At block 428, the dataset development component 204 may provide AI assisted labeling of images. For example, an AI algorithm may identify a scene shown in an image or a segment of an image and label the image or the segment accordingly. The AI algorithm may provide a machine learning system that is trained in real-time while labels are being created. The machine learning system is trained and begins to provide recommendations of labels of objects in geospatial images.

At block 422, the dataset development component 204 may validate the annotations. For example, a user may select to perform a basic validation (e.g., identifying false positive annotations and poor annotation quality) at block 426, or an area validation (e.g., identifying false negatives) at block 434. At block 438, the annotations are reviewed, and if validation is failed, feedback may be provided at block 442 to be used for making adjustments to annotations at block 430. At block 436, the annotated dataset may be shared or exported by the user.

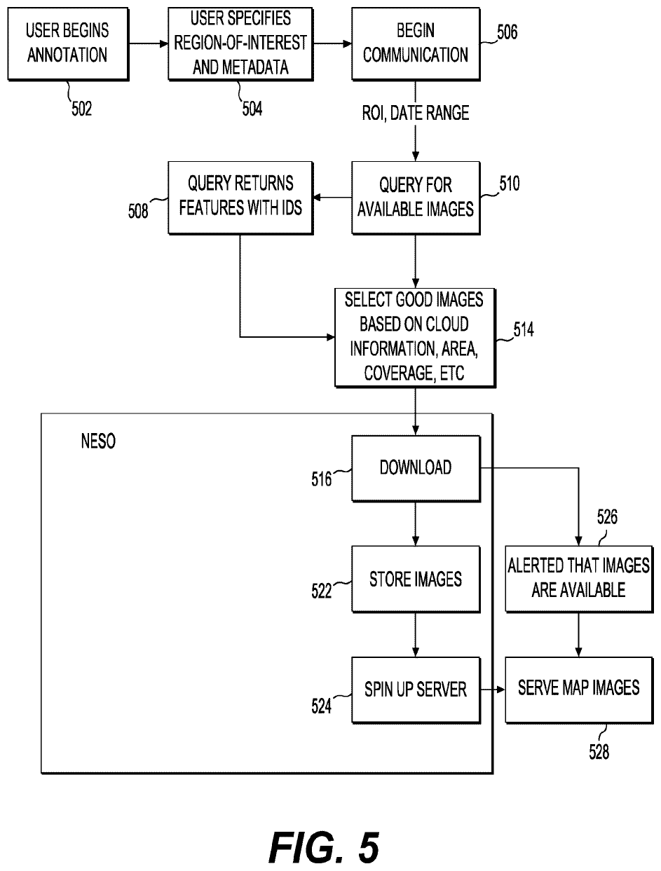

FIG. 5 illustrates example operations for dataset creation, in accordance with certain aspects of the present disclosure. At block 502, a user may begin annotation using a user interface provided by the dataset development component 204. At block 504, the user specifies a region of interest and metadata from which the user wants geospatial images. At block 506, the dataset development component 204 may communicate with the image sourcing component 202, and at block 510, queries the image sourcing component 202 for available images. At block 508, the query returns various features and IDs. At block 514, the dataset development component 204 selects from the available images based on cloud information or area coverage.

At block 516, the image sourcing component downloads the selected images (e.g., in full quality). At block 522, the image sourcing component 202 stores the images in a database, and at block 524, initiates a server to host the images. At block 526, the dataset development component 204 may be alerted that images are available (e.g., the download at block 516 has been completed). At block 528, the dataset development component 204 uses the server set up by the image sourcing component 202 to serve the map images to the user.

When an annotation task is created on dataset development component 204, all the images may be available in the platform in one or more formats. The data processing component 206 may receive the annotated dataset generated by the dataset development component 204 and generate a trainable dataset (also referred to as a training dataset) that may be provided to training component 208. A training dataset is an annotated dataset that has been split into parts (e.g., training, testing and validation) to allow for model training and performance analysis. An experiment component 210 may facilitate the generation of experiments to be provided to the training component 208 to generate a trained model. For example, a researcher may use a user interface to indicate that a particular experiment is to run on the dataset, which may be provided to the training component 208 and used to generate the trained model.

The generated trained model may then be provided to a model deployment component 212. In order to rely on a mission-critical model there should be a clear demonstration that the model works under real-world conditions. Model deployment component 212 exposes a series of tests that can be conducted to evaluate a model's performance under a broad range of conditions. Through this test bay, users can benchmark their model's performance before using it in mission-critical environments. Model deployment component 212 enables model auditing by providing a test-bay or sandboxing user interface where models developed under lab conditions can be performance benchmarked and tested against real-world conditions. For instance, a model designed to track infrastructure development in Pakistan may not be well suited for the environment and geography of Sudan. With model deployment component 212, users see what a model is graded for and where there might be blind spots that the model is not equipped to address. Model deployment component 212 supports benchmarking which provides a means for users to understand the context in which a model will perform well, and also importantly, when it will not. Model deployment component 212 supports the deployment of trained models as production APIs so that they can be consumed by user for real-time analysis on historical and future satellite image streams. Model pruning and quantization may be used to make inference efficient. Model deployment component 212 supports grading which allows users to understand and generate reports on how well a model performs with different inputs (e.g., the spatial and spectral properties of the imagery). Model deployment component 212 also supports ongoing validation which allows users to preemptively address issues of model performance degradation over time.

In some aspects, geospatial processing system 200 may include an inference component 214. Inference component 214 may enable non-technical users to deploy inference workflows and investigate model outputs. By mapping geospatial machine learning operations to business needs, inference component 214 effectively bridges the gap between domain awareness and technical requirements. In the inference platform, users can select and deploy model APIs based on model performance and applicability to the user's query. Once the model API is available, the user can interrogate imagery. With cluster management, models are capable of autoscaling to support global-scale analytical requirements. Inference workflows support Region-of-Interest (RoI) subscriptions, enabling users to run models against dynamically fetched imagery for their desired location at regular intervals (daily, weekly, monthly). Imagery is fetched via image sourcing component 202 based on model and user requirements, obviating the need for manual data acquisition for one-off or recurring analysis. These workflows may be executed while associated client libraries enable the downstream consumption of the resulting output data, making it easier to bring resultant model data into external environments for visualization, analysis and decision making. As shown, an analytics user 216 may run inference workflows using the inference API hosted by inference component 214. Inference results may be saved to database 218 and notification of the availability of the results may be provided to analytics user 216.

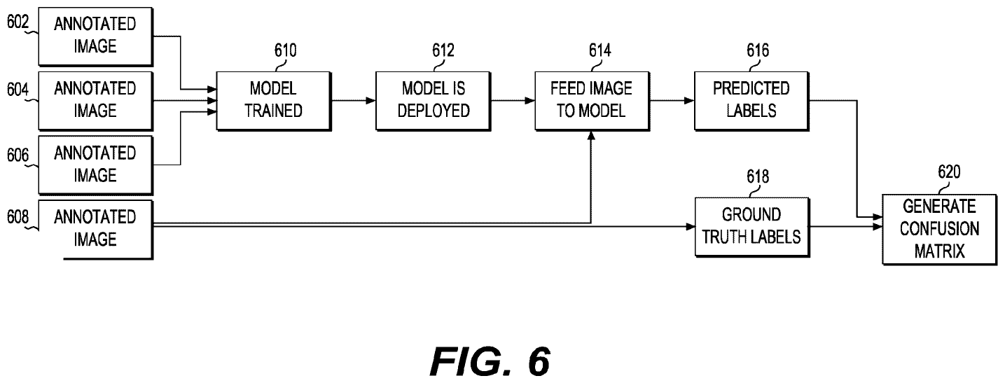

FIG. 6 illustrates example techniques for generating a model performance report, in accordance with certain aspects of the present disclosure. A confusion matrix is a table that is used to define the performance of a machine learning model(e.g. a classification algorithm). As shown, annotated images 602, 604, 606 (e.g., from image sourcing component 202) may be used to train a machine learning model at block 610 (e.g., via training component 208). The trained model is deployed at block 612 via model deployment component 212. At block 614, image 608 may be fed to the model to generate predicted labels 616. The image 608 may include labels serving as ground truths 618, which may be compared to the predicted labels 616 to generate the confusion matrix 620.

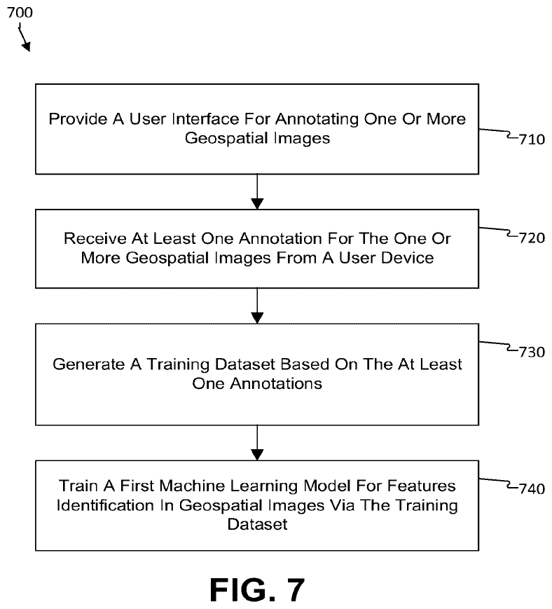

FIG. 7 illustrates example operations 700 for geospatial image processing, in accordance with certain aspects of the present disclosure. The operations 700 may be performed by a geospatial processing system (e.g., geospatial processing system 138 or geospatial processing system 200).

The operations 700 begin, at block 710, with the processing system providing a user interface for annotating one or more geospatial images. At block 720, the processing system receives at least one annotation for the one or more geospatial images from a user device. At block 730, the processing system generates a training dataset based on the at least one annotation. At block 740, the processing system trains a first machine learning model for features identification in geospatial images via the training dataset.

In some cases, AI assisted labeling may be implemented. For example, the processing system may generate, via a second machine learning model, an annotation recommendation for the one or more geospatial images. The processing system may provide the annotation recommendation to the user device via the user interface. Receiving the at least one annotation may include receiving an acceptance of the annotation recommendation. In some cases, the processing system may receive, via the user interface, one or more other annotations for the one or more geospatial images. The processing system may train the second machine learning model based on the one or more one or more other annotations. For instance, the second machine learning model may be continuously trained and improved as users annotate images and begins providing annotation recommendations to facilitate efficiency.

In some aspects, the processing system receives, from the user device and via the user interface, a request for geospatial imagery of an area of interest. The processing system may determine whether the one or more geospatial images are available in a local database of geospatial imagery in response to the request, and obtain the one or more geospatial images based on the determination. For example, the one or more geospatial images are obtained from a third party geospatial imagery source based on the one or more geospatial images being unavailable in the local database.

In some aspects, the processing system may obtain, via the user interface, one or more experiments for training the first machine learning model. Training the first machine learning model may include running the one or more experiments with the first machine learning model.

In some aspects, the processing system may select (e.g., via the first machine learning model) an area of interest for identifying a geospatial feature based on a first geospatial image. For instance, the processing system may select a portion of a geospatial image covering a large area of land as likely having a feature to be identified. The processing system may then receive (e.g., in response to a request from an image source) a second geospatial image of the area of interest and identify the geospatial feature via the second geospatial image. A resolution associated with the second geospatial image may be greater than a resolution associated with the first geospatial image.

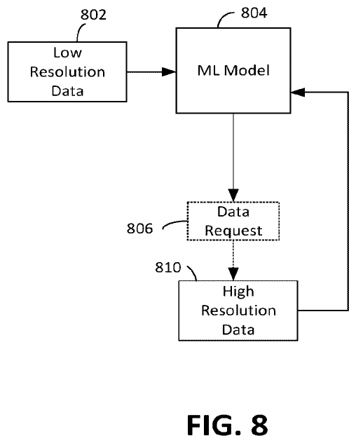

FIG. 8 illustrates example techniques for feature identification, in accordance with certain aspects of the present disclosure. As shown, at block 802, the processing system may obtain low resolution data such as geospatial imagery showing a large area of land. Using a machine learning model 804, the imagery may be analyzed to find an area of interest where a feature to be identified may likely be present. Based on the output from the machine learning model 804, the request for additional data (e.g., imagery of the area of interest) may be sent at block 806. In response, high resolution imagery 810 from a source, which may be provided to the machine learning model 804 for further processing to identify the feature.

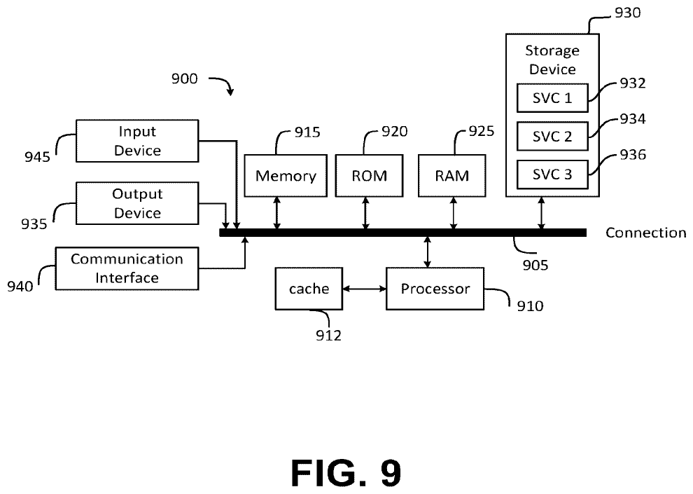

FIG. 9 illustrates an architecture of a computing system 900 wherein the components of the system 900 are in electrical communication with each other using a connection 905, such as a bus. Exemplary system 900 includes a processing unit (CPU or processor) 910 and a system connection 905 that couples various system components including the system memory, such as read only memory (ROM) 920 and random access memory (RAM) 925, to the processor 910. The system 900 can include a cache of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory may be available for use as well. The memory 915 can include multiple different types of memory with different performance characteristics. The processor 910 can include any general purpose processor and a hardware or software service, such as service 1 932, service 2 934, and service 3 936 stored in storage device 930, configured to control the processor 910 as well as a special-purpose processor where software instructions are incorporated into the actual processor design. The processor 910 may be a completely self-contained computing system, containing multiple cores or processors, a bus, memory controller, cache, etc. A multi-core processor may be symmetric or asymmetric.

To enable client interaction with the computing system 900, an input device 945 can represent any number of input mechanisms, An output device 935 can also be one or more of a number of output mechanisms known to those of skill in the art. In some instances, multimodal systems can enable a client to provide multiple types of input to communicate with the computing system 900. The communications interface 940 can generally govern and manage the client input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include services 932, 934, 936 for controlling the processor 910. Other hardware or software modules are contemplated. The storage device 930 can be connected to the system connection 905. In one aspect, a hardware module that performs a particular function can include the software component stored in a computer-readable medium in connection with the necessary hardware components, such as the processor 910, connection 905, output device 935, and so forth, to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function. Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, mobile phones (e.g., smartphones or other types of mobile phones), tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the following description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method for geospatial image processing, comprising:
providing a user interface for annotating one or more geospatial images;
receiving at least one annotation for the one or more geospatial images from a user device;
generating a training dataset based on the at least one annotation; and
training a first machine learning model for features identification in geospatial images via the training dataset.

2. The method of claim 1, further comprising:
generating, via a second machine learning model, an annotation recommendation for the one or more geospatial images; and
providing the annotation recommendation to the user device via the user interface, wherein receiving the at least one annotation includes receiving an acceptance of the annotation recommendation.

3. The method of claim 2, further comprising:
receiving, via the user interface, one or more other annotations for the one or more geospatial images; and
training the second machine learning model based on the one or more one or more other annotations.

4. The method of claim 1, further comprising:
selecting an area of interest for identifying a geospatial feature based on a first geospatial image;
receiving a second geospatial image of the area of interest; and
identifying the geospatial feature via the second geospatial image.

5. The method of claim 4, wherein a resolution associated with the second geospatial image is greater than a resolution associated with the first geospatial image.

6. The method of claim 4, wherein the area of interest is selected via the first machine learning model.

7. The method of claim 1, further comprising:
receiving, from the user device and via the user interface, a request for geospatial imagery of an area of interest;
determining whether the one or more geospatial images are available in a local database of geospatial imagery in response to the request; and
obtaining the one or more geospatial images based on the determination.

8. The method of claim 7, wherein the one or more geospatial images are obtained from a third party geospatial imagery source based on the one or more geospatial images being unavailable in the local database.

9. A non-transitory computer-readable medium having instructions stored thereon, which when executed by at least one processor, causes the at least one processor to:
provide a user interface for annotating one or more geospatial images;
receive at least one annotation for the one or more geospatial images from a user device;
generate a training dataset based on the at least one annotation; and
train a first machine learning model for features identification in geospatial images via the training dataset.

10. The non-transitory computer-readable medium of claim 9, wherein the instructions further cause the at least one processor to:
generate, via a second machine learning model, an annotation recommendation for the one or more geospatial images; and
provide the annotation recommendation to the user device via the user interface, wherein receiving the at least one annotation includes receiving an acceptance of the annotation recommendation.

11. The non-transitory computer-readable medium of claim 10, wherein the instructions further cause the at least one processor to:
receive, via the user interface, one or more other annotations for the one or more geospatial images; and
train the second machine learning model based on the one or more one or more other annotations.

12. The non-transitory computer-readable medium of claim 9, wherein the instructions further cause the at least one processor to:
select an area of interest for identifying a geospatial feature based on a first geospatial image;
receive a second geospatial image of the area of interest; and
identify the geospatial feature via the second geospatial image.

13. The non-transitory computer-readable medium of claim 12, wherein a resolution associated with the second geospatial image is greater than a resolution associated with the first geospatial image.

14. The non-transitory computer-readable medium of claim 12, wherein the area of interest is selected via the first machine learning model.

15. The non-transitory computer-readable medium of claim 9, wherein the instructions further cause the at least one processor to:
receive, from the user device and via the user interface, a request for geospatial imagery of an area of interest;
determine whether the one or more geospatial images are available in a local database of geospatial imagery in response to the request; and
obtain the one or more geospatial images based on the determination.

16. The non-transitory computer-readable medium of claim 15, wherein the one or more geospatial images are obtained from a third party geospatial imagery source based on the one or more geospatial images being unavailable in the local database.

17. A system for geospatial image processing, comprising:
a user interface subsystem configured to provide a user interface for annotating one or more geospatial images and receive at least one annotation for the one or more geospatial images from a user device;
a data processing component configured to generate a training dataset based on the at least one annotation; and
a training component configured to train a first machine learning model for features identification in geospatial images via the training dataset.
